(19) United States
(12) Patent Application Publication
(10) Pub. No.: US 2008/0279490 A1
(43) Pub. Date: Nov. 13, 2008

(54) SLIDING FRICTION REDUCER

(75) Inventor: Gregory Jon Holcomb, Cedar Falls, IA (US)

Correspondence Address: CALFEE, HALTER & GRISWOLD LLP, 1400 KEYBANK CENTER, 800 SUPERIOR AVENUE, CLEVELAND, OH, 44114, US

(73) Assignee: WATERLOO INDUSTRIES, INC., Waterloo, IA (US)

(21) Appl. No.: 11/745,569

(22) Filed: May 8, 2007

(51) Int. Cl. F16C 33/00

(52) U.S. Cl. 384/42; 206/349; 312/350; 384/26

(57) ABSTRACT

A friction reducer is positioned between a bar component and a channel in which an edge of the bar is enclosed during relative motion between the bar and the channel. The friction reducer is made of a material that presents a lower friction surface upon which the relative motion occurs.

### FIELD OF THE INVENTION

The present invention relates to a friction reducer and to a sliding friction reducer between a bar component and a channel.

### BACKGROUND

Many mechanical devices have a moving mechanism that includes a bar component that slides within a channel that closely fits along long sides of the bar. The closeness of the fit between the bar and the channel impacts many functional aspects of the mechanism. For example, depending on the frictional characteristics of the material of the bar and the channel, an overly close fit may result in a mechanism that presents too much drag as the bar is moved in the channel. On the other hand, while a looser fit between the bar and the channel may result in easier sliding, the mechanism may rattle when moved or become jammed due to misalignment between the bar and the channel. When both the bar and the channel are formed from a relatively rigid material, such as metal, it is difficult to compensate for these variations in component interaction that routinely occur due to many reasons such as manufacturing tolerance stack up.

### SUMMARY

A friction reducer is positioned between a bar component and a channel in which an edge of the bar is enclosed during relative motion between the bar and the channel. The friction reducer is made of a material that presents a lower friction surface upon which the relative motion occurs. The friction reducer may be, for example, a tab that snaps onto the edge of the bar and covers the front, side, and back of the edge of the bar at spaced locations along the edge of the bar. The friction reducer may be, for example, an insert that fits into the channel at locations along the length of the channel and provides a close fitting slot in which the edge of the bar may ride. The friction reducer may be, for example, a substantially continuous strip that folds around the front, side, and back edge of the bar along its length. The friction reducer may be, for example, a substantially continuous lining of friction reducing material in the channel.

Further features and advantages of the invention will become apparent from the following detailed description made with reference to the accompanying drawings.

### BRIEF DESCRIPTION OF THE DRAWINGS

In the accompanying drawings, which are incorporated in and constitute a part of this specification, embodiments of the invention are illustrated, which, together with the description of the invention serve to illustrate the principles of this invention. The drawings and detailed description are not intended to and do not limit the scope of the invention or any subsequent claims in any way. Instead, the drawings and description only describe embodiments of the invention and other embodiments of the invention not described are encompassed by this disclosure of the invention.

FIG. 1 is a perspective view of a sliding bar within a guide channel that is cut away to show a friction reducing tab installed on the sliding bar according to an embodiment of the present invention;

FIG. 2 is a cross section of the sliding bar and guide channel of FIG. 1;

FIG. 3 is an exploded perspective view of the sliding bar and friction reducing tab of FIG. 1;

FIG. 4 is a perspective view of a tool storage cabinet that includes a sliding lock bar within a guide channel according to an embodiment of the present invention;

FIG. 5 is a cut away view of a guide channel that includes friction reducing inserts according to an embodiment of the present invention;

FIG. 6 is a cut away perspective view of a sliding bar that includes a friction reducing edge wrap according to an embodiment of the present invention; and

FIG. 7 is a cut away perspective view of a guide channel that includes a friction reducing liner according to an embodiment of the present invention.

### DESCRIPTION OF THE INVENTION

The Description of the Invention merely describes preferred embodiments of the invention and is not intended to limit the scope of the specification or claims in any way. Indeed, the invention as described by the claims is broader than and unlimited by the preferred embodiments, and the terms in the claims have their full ordinary meaning.

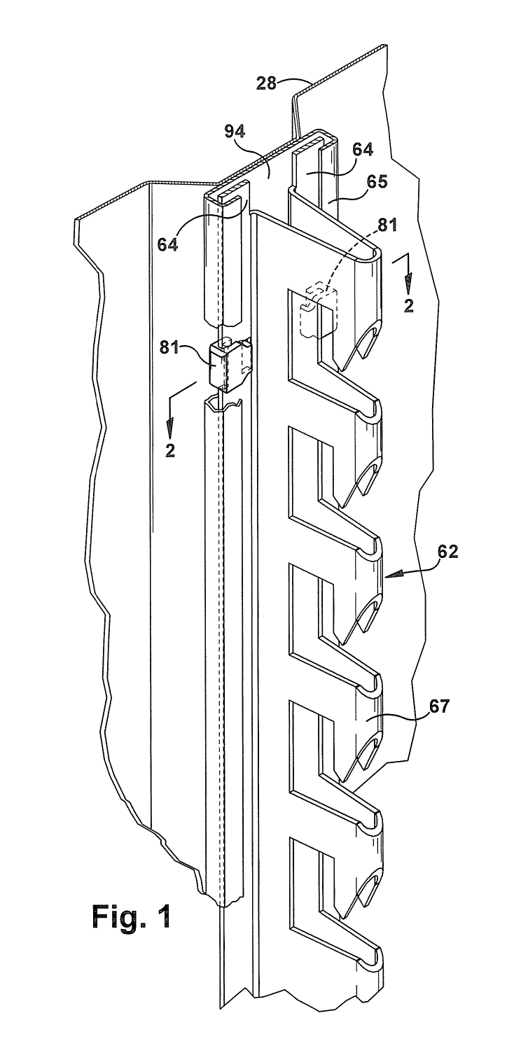

FIG. 1 illustrates a lock bar 62 that slides within a lock bar guide channel 94. The lock bar 62 is formed by bending a metal strip 64 into a flanged V-shape into which drawer catches 67 are machined. The lock bar 62 is a particular type of bar component that can be used in practice of the present invention. It will be apparent to one of skill in the art that the friction reducers that will be described herein can be used with any type of bar component having edges that slide within a channel. As will be described in more detail below, the lock bar 62 is moved vertically within the lock bar guide channel 94 in response to movement of a key cylinder to selectively lock or unlock drawers in a lockable chest. Friction reducing tabs 81 are snapped onto the outer edge of the metal strip 64 periodically along its length. These friction reducing tabs 81 provide a reduced friction surface upon which the lock bar 62 slides within the lock bar guide channel 94.

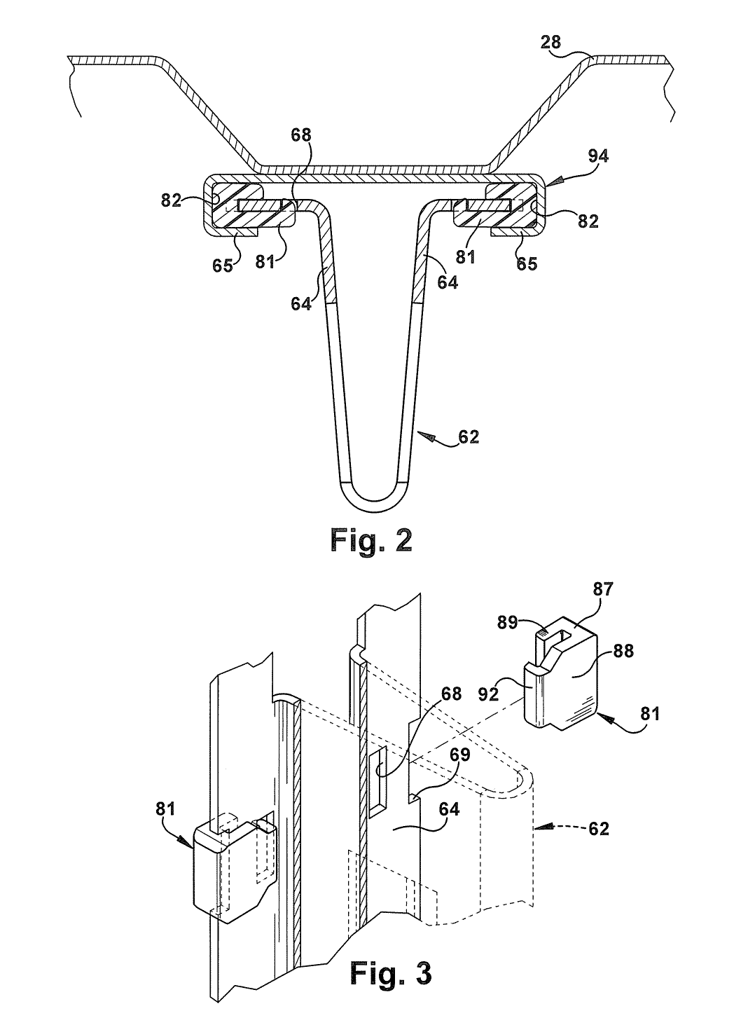

FIG. 2 illustrates the friction reducing tabs 81 installed on opposing edges of the lock bar 62 and fitted into the lock bar guide channel 94 within an outer channel portion 82. The friction reducing tabs 81 are made from a material, such as for example, nylon, that provides a low friction interface with the metal of the lock bar guide channel. In addition to providing a low friction interface, it may also be advantageous for the material of the tab 81 to have elastomeric qualities so that it may be compressed to some extent within the outer channel portion 82 to compensate for variations in the amount of clearance between the lock bar metal strip 64 and the outer channel portion 82.

FIG. 3 shows a friction reducing tab 81 in an exploded orientation relative the lock bar metal strip 64. To facilitate installation of the friction reducing tabs, the lock bar metal strip includes notches 69 and tab mounting holes 68 along its edges. The friction reducing tab includes an ear 92 that is sized to snap into the mounting hole 68. The ear 92 projects from a tab channel that is formed by a front tab wall portion 88, an outer tab wall portion 87, and a rear tab wall portion 89. As can also be seen in FIG. 2, once the tab 81 is snapped into the mounting hole 68, the tab channel fits within the notch 69. The front, outer, and rear tab wall portions 87, 88, 89 protrude from the notch 69 and extend beyond the edge of the metal strip 64. In this manner, the friction reducing tab 81 becomes the point of contact between the lock bar 62 and the guide channel 94. In particular, the outer surface of the tab channel becomes a sliding interface surface that provides reduced friction.

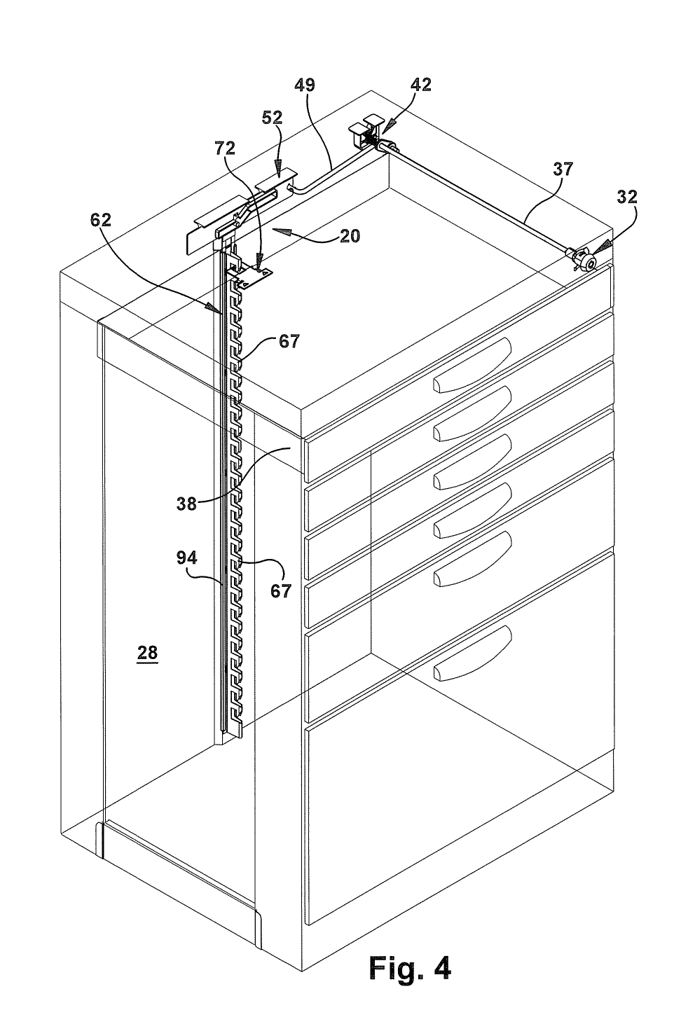

FIG. 4 is a perspective view of a lockable drawer chest 10, such as for example, a tool chest with its walls in phantom. It should be appreciated that a chest is shown for exemplary purposes only, and that any other container could be used, such as for example, a tool cabinet. The chest 10 includes the lock bar 62 and lock bar guide channel 94 described above as well as the friction reducing tabs 81. The use of the friction reducers between a lock bar and a lock bar guide channel is but one example of a sliding bar mechanism in which the friction reducing techniques discussed herein can be used. The chest defines a cavity in which drawers 38 are slideably mounted. The chest is lockable, such that the drawers can be locked in the closed position. The chest includes a key cylinder 32 that is rotatable upon insertion of a proper key. The lock bar 62 is moved between a locked position and an unlocked position by the actuator when the key cylinder 32 is rotated. When the lock bar is moved downward to the locked position, a catch 67 on the lock bar is aligned with the striker plate 72 to hold the drawer in the closed position. When the lock bar is moved upward to the unlocked position, the catch is not aligned with the striker plate and the drawer can be opened.

The lock bar 62 is slideably retained in a lock bar channel 94 on the rear wall 28 of the chest. The lock bar channel is formed from a strip of metal and includes a pair of spaced rolled flanges that form the outer channel portion 82 and in which the side edges of the metal strip 64 are enclosed. The edges of the metal strip 64 include one or more notches 69. As discussed above, friction reducing tabs 81 are pressed into the notches 69. The friction reducing tabs are thicker than the metal strip 64 and therefore the lock bar rides on the friction reducing inserts 81 as it is moved within the lock bar channel 94. The friction reducing inserts may be made from nylon or other suitable material.

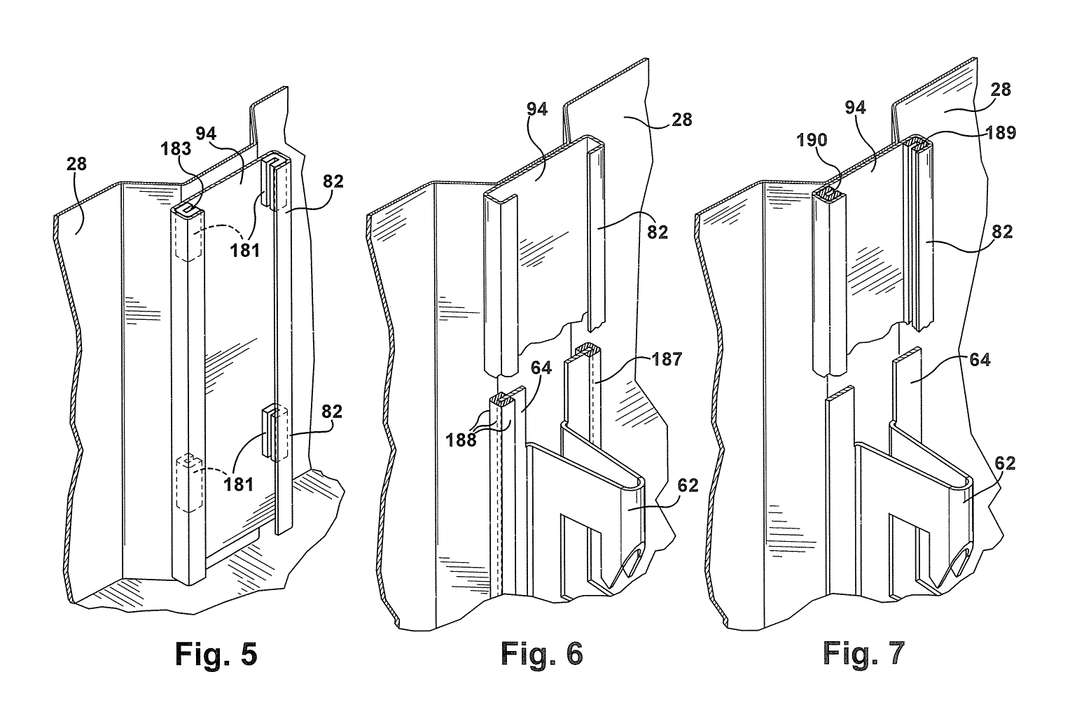

FIG. 5 illustrates an alternative friction reducer arrangement. Friction reducing inserts 181 are pressed into the outer channel portion 82 of the guide channel. The friction reducing inserts may be made of nylon or other suitable material. The friction reducing inserts are substantially U-shaped and are sized to be maintained in position by frictional engagement with the outer channel portion 82. Locating features (not shown) around an outer surface of the insert may be provided that connect to mating features in the outer channel portion. An inner insert channel 183 provides a reduced friction surface upon which the metal strip rides when the lock bar is moved relative to the guide channel.

FIG. 6 illustrates a substantially continuous friction reducing edge wrap 187. The edge wrap 187 is U-shaped with an inner channel that closely fits around the edge of the metal strip 64. The edge wrap may be made from nylon or other suitable material or may be coating of friction reducing material that is applied to the metal strip 64 in liquid form and cures to form the edge wrap 187. An outer wrap surface 188 provides a reduced friction surface that slides within the outer channel portion 82 when the lock bar is moved relative to the guide channel.

FIG. 7 illustrates a substantially continuous liner 189 that is fitted into the outer channel portion 82. The liner 189 is U-shaped and configured to closely contain the metal strip 64 within an inner channel. The liner may be molded from nylon or other suitable material. An inner liner channel 190 provides a reduced friction surface upon which the metal strip rides when the lock bar is moved relative to the guide channel.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adapt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

What is claimed is:

1. A friction reducer for use with a sliding bar mechanism that permits constrained relative motion between a bar component and a guide channel wherein the bar component includes an edge that is slideably engaged within the guide channel, the friction reducer comprising:
an inner surface contoured to match an outer surface of the bar component edge; and
an outer surface contoured to match an inner surface portion of the guide channel that engages the bar component edge;
wherein at least one of the inner and outer surfaces includes a reduced friction surface upon which the relative motion between the bar component and guide channel occurs.

2. The friction reducer of claim 1 wherein the friction reducer is molded from nylon.

3. The friction reducer of claim 1 comprising mounting features and the bar component includes friction reducer installation features configured to co-act with the mounting features to engage the friction reducer to the bar component.

4. The friction reducer of claim 3 comprising a U-shaped portion and an ear projecting orthogonally inward from the U-shaped portion and wherein the bar component includes a mounting hole into which the ear snaps and a notch on the bar component edge into which the friction reducer is seated and wherein the friction reducer has an outer reduced friction surface that moves within the guide channel during relative motion between the bar component and the guide channel.

5. The friction reducer of claim 1 comprising a U-shaped portion and wherein the friction reducer is fixed in position within the guide channel and wherein the friction reducer has an inner reduced friction surface in which the bar component edge rides during relative motion between the bar component and the guide channel.

6. The friction reducer of claim 5 wherein the friction reducer is substantially continuous along the length of the guide channel.

7. The friction reducer of claim 1 wherein the friction reducer comprises a U-shaped portion that is fixed in position on the bar component edge and wherein the friction reducer has an outer reduced friction surface that moves within the guide channel during relative motion between the bar component and the guide channel.

8. The friction reducer of claim 7 wherein the friction reducer is substantially continuous along a length of the bar component edge.

9. The friction reducer of claim 8 wherein the friction reducer is a coating that is applied to the bar component edge.

10. A sliding lock bar mechanism for use with a chest having a top wall, a bottom wall, a pair of spaced side walls and a rear wall that define a drawer cavity in which one or more drawers are housed, the drawers being moveable between an open and a closed position, sliding lock bar mechanism comprising:
a vertical lock bar slideably mounted to the back wall within a guide channel and moveable between a locked position and an unlocked position, the lock bar including a catch aligned with a striker on a corresponding drawer that engages and retains the striker retention feature when the lock bar is in the locked position;
an actuator coupled to the lock bar configured to move the lock bar within the guide channel between the locked and unlocked position in response to movement of a chest lock mechanism; and
a friction reducer installed between the lock bar and guide channel, the friction reducer comprising:
an inner surface contoured to match an outer surface of an edge of the lock bar; and
an outer surface contoured to match an inner surface portion of the guide channel that engages the lock bar edge;
wherein at least one of the inner and outer surfaces includes a reduced friction surface upon which the relative motion between the lock bar and guide channel occurs.

11. The sliding lock bar mechanism of claim 10 wherein the friction reducer is molded from nylon.

12. The sliding lock bar mechanism of claim 10 wherein the friction reducer includes mounting features and the lock bar includes friction reducer installation features configured to co-act with the mounting features to engage the friction reducer to the lock bar.

13. The sliding lock bar mechanism of claim 12 wherein the friction reducer includes a U-shaped portion and an ear projecting orthogonally inward from the U-shaped portion and wherein the lock bar includes a mounting hole into which the ear snaps and a notch on the lock bar edge into which the friction reducer is seated and wherein the friction reducer has an outer reduced friction surface that moves within the guide channel during relative motion between the lock bar and the guide channel.

14. The sliding lock bar mechanism of claim 10 wherein the friction reducer comprises a U-shaped portion and wherein the friction reducer is fixed in position within the guide channel and wherein the friction reducer has an inner reduced friction surface in which the lock bar edge rides during relative motion between the lock bar and the guide channel.

15. The sliding lock bar mechanism of claim 14 wherein the friction reducer is substantially continuous along the length of the guide channel

16. The sliding lock bar mechanism of claim 10 wherein the friction reducer comprises a U-shaped portion that is fixed in position on the lock bar edge and wherein the friction reducer has an outer reduced friction surface that moves within the guide channel during relative motion between the lock bar and the guide channel.

17. The sliding lock bar mechanism of claim 15 wherein the friction reducer is substantially continuous along a length of the lock bar edge.

18. The sliding lock bar mechanism of claim 16 wherein the friction reducer is a coating that is applied to the lock bar edge.

19. A tool storage assembly comprising:
a) a container having a top wall, a bottom wall, a pair of spaced side walls and a rear wall that define a drawer cavity in which one or more drawers are housed, each drawer being moveable horizontally between an open and a closed position;
b) sliding lock bar mechanism comprising a vertical lock bar slideably mounted to the back wall within a guide channel and moveable vertically between a locked position, in which drawer movement is inhibited, and an unlocked position; and
c) a plurality of friction reducing reducers installed at spaced locations on the lock bar in an orientation between the lock bar and guide channel, wherein at least one of said plurality of friction reducers includes a reduced friction surface upon which the relative motion between the lock bar and guide channel occurs.

20. The tool storage assembly of claim 19 wherein at least one of the plurality of friction reducers are molded from nylon.

21. The tool storage assembly of claim 19 wherein at least one of the plurality of friction reducers defines a reducer channel and the lock bar includes an outer edge having an installation portion configured with a mounting hole to engage the installation portion within the reducer channel.
